(19) United States
(12) Patent Application Publication
(10) Pub. No.: US 2007/0222129 A1
(43) Pub. Date: Sep. 27, 2007

(54) Apparatus for isolating vibration

(76) Inventor: Jae Yeon Kim, Gunpo-city (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/647,074

(22) Filed: Dec. 28, 2006

(30) Foreign Application Priority Data
Mar. 21, 2006 (KR) 10-2006-0025781

(51) Int. Cl. F16F 7/00

(52) U.S. Cl. 267/141.3

(57) ABSTRACT

An apparatus for isolating vibration in plural pipes or tubes includes one isolator and according to the apparatus for isolating vibration, isolating performance is improved and cost is reduced because of a simple scheme thereof.

### CROSS-REFERENCE TO RELATED APPLICATION

This application claims priority to and the benefit of Korean Patent Application No. 10-2006-0025781 filed in the Korean Intellectual Property Office on Mar. 21, 2006, the entire contents of which are incorporated herein by reference.

### BACKGROUND OF THE INVENTION

(a) Field of the Invention

The present invention relates to an apparatus for isolating vibration. More particularly, the present invention relates to an apparatus for isolating vibration occurring, for example, in vehicle pipes or tubes.

(b) Description of the Related Art

Generally, an apparatus for isolating vibration can be used to prevent vibration in a vehicle pipe and tubes. The vibration that typically occur in vehicle pipes and tubes includes two kinds of vibration. One is a vibration transmitted to the pipe or tube from an air compressor mounted to the engine of the vehicle, a steering pump, or the engine itself and the other is from the vehicle body during vehicle operations.

Such vibration may be a cause reducing durability of vehicle elements and ride discomfort. For isolating the vibration, conventionally, in two or more pipes, two or more isolators are often disposed. Typically this may include plural brackets and plural isolator members, bar code or more associated with each pipe or tube. Such an arrangement may occur, for example, with coolant having low pressure flows in a first pipe and another coolant having high pressure flows in a second pipe. Therefore, vibration from a compressor of an air conditioner, a steering pump, and an engine can be transmitted to a vehicle body through the first pipe and the second pipe. In addition, vibration from in the vehicle body may be transmitted into an interior of the vehicle through the first pipe and the second pipe.

Therefore, according to the prior art, first and the second isolators are disposed to separately isolate each of the two pipes.

However, according to the prior art, because two or more isolators are mounted, problems occur that a scheme of the apparatus for isolating vibration is complicated and manufacturing cost increases. In addition, the first and the second isolators have to support the first and the second pipes more softly. However, in a case that first, second and third brackets are engaged, a problem occurs that in an isolating performance of the isolators can be deteriorated by an engaging force of the brackets. Furthermore, because performance of the isolators is deteriorated, a problem occurs that noise increases.

The above information disclosed in this Background section is only for enhancement of understanding of the background of the invention and therefore it may contain information that does not form the prior art that is already known in this country to a person of ordinary skill in the art.

### SUMMARY OF THE INVENTION

Embodiments of the present invention provide an apparatus for isolating vibration having advantages of simplifying scheme, reducing manufacturing cost, improving isolating performance, and reducing noise.

An exemplary embodiment of the present invention provides an apparatus for isolating vibration isolating vibration of a first pipe and a second pipe in which same fluids or different fluids flow including a bracket connecting a first pipe and a second pipe, and an isolator disposed between the first pipe and the first bracket and defining at least one hole therein to isolate vibration transmitted through the first pipe and the second pipe.

The bracket includes a first connecting portion connected to an exterior circumference of the isolator to connect the first pipe with the second pipe and a second connecting portion connected to the second pipe to connect the first pipe with the second pipe.

The isolator includes a bonding surface formed to an interior circumference of the isolator contacted to the first pipe and at least one groove formed to the bonding surface such that a bonding agent spreads to the bonding surface.

The isolator includes at least one protruding portion formed to an outer circumference of the isolator.

The first connecting portion includes at least one concave portion to pressurize at least one portion of the isolator.

The first connecting portion and the second connecting portion are integrally formed.

### BRIEF DESCRIPTION OF THE DRAWINGS

FIG. 1 shows an apparatus for isolating vibration according to exemplary embodiment of the present invention.

FIG. 2 is a cross-sectional view showing an isolator of an apparatus for isolating vibration according to an exemplary embodiment of the present invention.

FIG. 3 is a perspective view showing an isolator according to an exemplary embodiment of the present invention.

FIG. 4 shows a shape that a bracket is mounted to an isolator according to an exemplary embodiment of the present invention.

### DETAILED DESCRIPTION OF THE EMBODIMENTS

An exemplary embodiment of the present invention will hereinafter be described in detail with reference to the accompanying drawings.

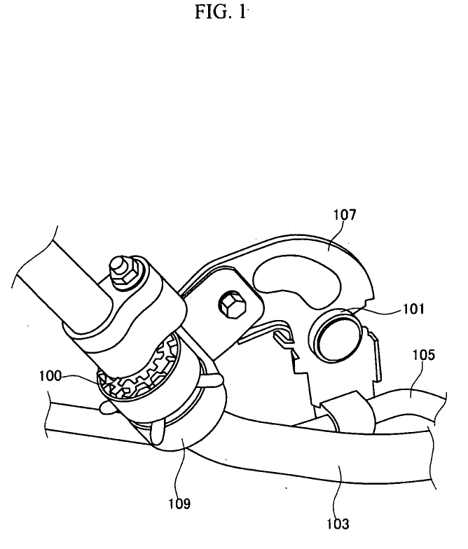

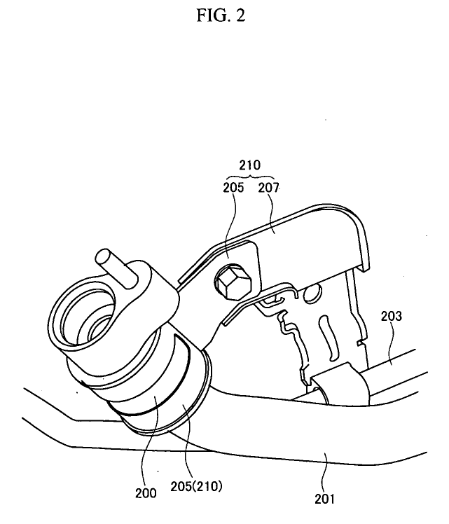

As shown in FIG. 1 and FIG. 2, according to an exemplary embodiment of the present invention, an apparatus for isolating vibration isolating vibration of a first pipe 201 and a second pipe 203 in which same fluids or different fluids flow includes a bracket 210 and an isolator 200. The bracket 210 connects the first pipe 201 with the second pipe 203. The isolator 200 is disposed between the first pipe 201 and the bracket 210 to isolate the vibration transmitted through the first pipe 201 and the second pipe 203 and forms at least one hole 301 therein.

According to an exemplary embodiment of the present invention, the isolator 200 may be made of a rubber material.

A fluid flows in the first and the second pipe 201 and 203. Therefore, according to an exemplary embodiment of the present invention, the apparatus for isolating vibration can be applied to all kinds of pipes or tubes disposed in or on the vehicle.

The first pipe 201 and the second pipe 203 in which different fluids flow are connected by the bracket 210 and the isolator 200 is mounted to an exterior circumference of the first pipe 201. The bracket 210 is coupled to an exterior circumference of the isolator 200. The bracket 210 includes a first connecting portion 205 and a second connecting portion 207.

The first connecting portion 205 is connected to an exterior circumference of the isolator 200 to connect the first pipe 201 with the second pipe 203. The second connecting portion 207 is connected to the second pipe 203 to connect the first pipe 201 with the second pipe 203. Referring to FIG. 1, according to an exemplary embodiment of the present invention, the first connecting portion 205 includes a ring shaped portion and the portion is mounted to the exterior circumference of the isolator 200.

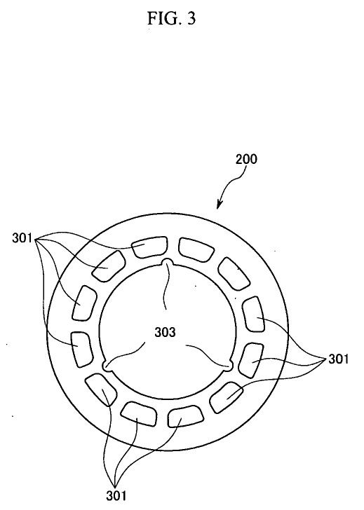

Referring to FIG. 3, at least one hole 301 formed to the isolator 200 may be formed as a plurality thereof in the isolator 200 in a cylindrical direction of the isolator 200. By the at least one hole 301, the isolator 200 can more effectively isolate the vibration.

Therefore, vibration occurring in a compressor of an air conditioner, a steering pump, and an engine and transmitted to the vehicle body or another vibration occurring in the vehicle body and transmitted through the first pipe 201 and the second pipe 203 can be isolated by one isolator 200.

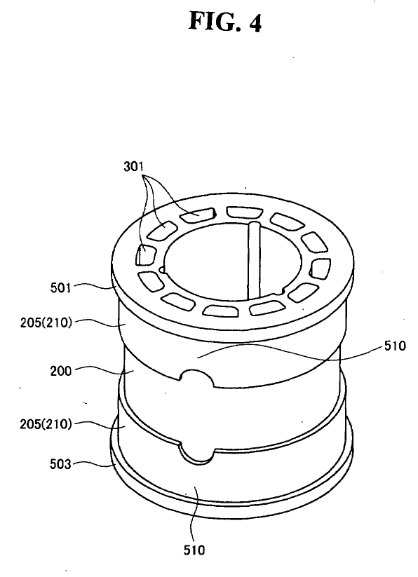

Referring to FIG. 4 and FIG. 5, the isolator 200 includes a bonding surface 400, at least one groove 303, and at least one protruding portions 501 and 503. The bonding surface 400 is formed to an interior circumference of the isolator 200.

The at least one groove 303 is formed to the bonding surface 400 such that a bonding agent spreads to the bonding surface 400 and the at least one protruding portions 501 and 503 are formed to an outer circumference of the isolator 200.

According to an exemplary embodiment of the present invention, the at least one groove 303 is formed as three, but not limited thereto. According to a further exemplary embodiment of the present invention, the at least one groove 303 is formed and the bonding agent can spread by the groove 303. Therefore, because more small connecting force of the bracket 210 acts to the isolator 200, an isolating performance of the isolator 200 can be improved.

In addition, referring to FIG. 5, the protruding portions 501 and 503 include a protruding portion 501 formed to an upper portion of the isolator 200 and a protruding portion 503 formed to a lower portion thereof. The first connecting portion 205 can not be separated from the isolator 200 and can be stably connected thereto by the protruding portions 501 and 503 although the vibration occurs. In addition, by the protruding portions 501 and 503, a position of a deviation between the isolator 200 and the first connecting portion 205 of the bracket 210 can not occur.

Referring again to FIG. 5, the first connecting portion 205 includes at least one concave portion 510 formed to pressurize at least one portion of the isolator 200. That is, the concave portion 510 is formed by which one portion of the first connecting portion 205 is depressed to a central direction of the isolator 200. Because the isolator portion corresponding to concave portion 510 is compressed thereby, an elastic force of the isolator 200 can be enhanced. Therefore, the isolating performance of the isolator 200 can be improved by the concave portion 510.

On the other hand, according to an exemplary embodiment of the present invention, the first connecting portion 205 and the second connecting portion 207 can be integrally formed. Therefore, manufacturing cost may be reduced.

According to an exemplary embodiment of the present invention, because one isolator is disposed and a number of the brackets is reduced, a scheme of the apparatus for isolating vibration is simplified and manufacturing cost can be reduced. In addition, the isolating performance of the isolator can be improved and noise is reduced. Furthermore, the isolating performance of the isolator can be improved by the concave portion.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An apparatus for isolating vibration isolating vibration in at least a first pipe and a second pipe, in which same fluids or different fluids flow, comprising:
a bracket connecting the first pipe and the second pipe; and
an isolator disposed between the first pipe and the first bracket and defining at least one hole therein to isolate vibration transmitted through the first pipe and the second pipe.

2. The apparatus of claim 1, wherein the bracket comprises:
a first connecting portion connected to an exterior circumference of the isolator to connect the first pipe with the second pipe; and
a second connecting portion connected to the second pipe to connect the first pipe with the second pipe.

3. The apparatus of claim 1, wherein the isolator comprises,
a bonding surface formed to an interior circumference of the isolator contacted to the first pipe; and
at least one groove formed to the bonding surface such that a bonding agent spreads to the bonding surface.

4. The apparatus of claim 1, wherein the isolator comprises at least one protruding portion formed to an outer circumference of the isolator.

5. The apparatus of claim 2, wherein the first connecting portion comprises: at least one concave portion to pressurize at least one portion of the isolator.

6. The apparatus of claim 2, wherein the first connecting portion and the second connecting portion are integrally formed.
